(19) United States
(12) Patent Application Publication
(10) Pub. No.: US 2007/0031625 A1
(43) Pub. Date: Feb. 8, 2007

(54) Low application temperature hot melt adhesive and use thereof in packaging applications

(75) Inventors: Lie-zhong Gong, Bridgewater, NJ (US); Abhi Narthana, Belle Mead, NJ (US)

Correspondence Address: NATIONAL STARCH AND CHEMICAL COMPANY, P.O. BOX 6500, BRIDGEWATER, NJ, 08807-3300, US

(73) Assignee: National Starch and Chemical Investment Holding Corporation

(21) Appl. No.: 11/197,230

(22) Filed: Aug. 4, 2005

(51) Int. Cl. B32B 33/00; B31B 1/60; B05D 5/10; C09J 5/00; B32B 7/12

(52) U.S. Cl. 428/40.1; 428/343; 156/60; 427/208.2; 156/305

(57) ABSTRACT

Low application temperature hot melt adhesives are advantageously used to releaseably bond an article, such as a plastic bottle to a base material, such as a cardboard palette.

### FIELD OF THE INVENTION

The invention relates to hot melt adhesives with both excellent bonding and releasing characteristics.

### BACKGROUND OF THE INVENTION

Packaging costs associated with the bundling of goods for sale and/or transport add considerably to the costs borne by the consumer of the goods. In order to reduce the cost of consumer products, in particular commodity goods such as bottled water, juices, soft drinks and the like, reduction in the cost of packaging materials is desirable. To this end, plastic bottles may be placed upon the surface of a piece of corrugated board and then wrapped with, e.g., shrink wrap plastic material. In order to retain the bottles in place during the shrink wrap procedure the bottles may be adhered to the corrugated board with an adhesive, in particular a hot melt adhesive. Use of adhesives is particularly desirable when the cardboard or corrugated board used is a flat planar piece of board with no side walls for containment of the bottles. However, use of hot melt adhesives to keep the bottles in place during packaging makes the bottles difficult to remove and, following removal, adhesive often adheres to the bottom of the bottle, a condition that is not aesthetically pleasant and one which interferes with the ability of the bottle to sit erect on a flat surface such as a refrigerator shelf, a table top or a tray. There is thus a need in the art for adhesives that can be used to temporarily hold an article in place, e.g., during a packaging operation, and thereafter easily release for clean separation of the article from the adhesive and packaging substrate to which it was bonded and without leaving adhesive residue on the bottle. The current invention addresses this need.

### SUMMARY OF THE INVENTION

It has now been discovered that the bonding and releasing performance of hot melt adhesives, specifically low application temperature hot melt adhesives, may be adjusted by carefully selecting the combination of polymers, tackifiers, waxes and processing additives.

One embodiment of the invention is directed to low application temperature hot melt adhesives which, when used to bond two dissimilar substrates together, exhibits strong bonding characteristics over a range of from about 5 seconds to about 30 minutes following initial bonding, which bonds weaken over time such that by at least 24 hours following initial bonding, the bond strength is reduced by at least 50% and the substrates can be easy separated without adhesive transfer to at least one of said substrates. In one preferred embodiment the adhesive will contain high molecular weight ethylene vinyl acetate (MI lower than about 400 g/10 min), a high wax content (greater than about 40 wt %, preferably between 40 and 50 wt %) and a viscosity at 250° F. of less than about 4000 cp.

Another embodiment is directed to a method of at least temporarily bonding one substrate to a second substrate using a low application temperature hot melt adhesive. In this embodiment, one substrate is strongly bonded to a second different substrate using a hot melt adhesive applied at a temperature of from about 200° F. to about 300° F. After a predetermined period of time, the adhesive bond weakens considerably and the bond can be easily broken interfacially without adhesive transfer to one of the two substrates. In one aspect of this embodiment, plastic, glass or metal containers and the like are temporarily secured to a paperboard substrate during packaging.

In the method of the invention a first substrate is bonded to a second different substrate by applying a low application temperature hot melt adhesive to a first substrate surface, and then contacting the adhesive present on the first substrate surface with a surface of the second substrate, thereby strongly bonding the first and second substrates together for a period ranging from 5 seconds to 30 minutes, thereafter bond strength declining over time such that by 24 hours following contact, the first and second substrates may be easily separated with only slight force without adhesive transfer to one of the two substrates. For example, when bonding a plastic bottle to a corrugated board (sometimes also referred to herein as a palette) the adhesive bond fails intefacially between the plastic container and the adhesive without adhesive transfer to the container and with no fiber tear of the corrugated medium.

Another embodiment of the invention is directed to a composite comprising one substrate bonding to a second different substrate with a low application temperature hot melt adhesive that is capable of bonding to substrates strongly after the bonds are aged for a predetermined period of time (e.g., from about 5 seconds to about 30 minutes). However, after being conditioned at room temperature for about 24 hours, the adhesive bonds weaken significantly and can be broken interfacially without adhesive transfer to one of two substrates.

Yet another embodiment is directed to a method of packaging articles. In one aspect of this embodiment, plastic, glass or metal containers and the like are temporarily secured to a paperboard substrate during packaging. The method of the invention can advantageously be used to bulk package a plurality of items such as, for example, a plurality of containers. Bottles, cans, jars or the like can conveniently be packaged together.

A further embodiment is directed to packaged articles. In one aspect the packaged articles comprises a plurality of items such as containers, e.g., bottle, cans, jars or the like.

### DETAILED DESCRIPTION OF THE INVENTION

The invention relates to hot melt adhesives with both excellent bonding and releasing characteristics. The adhesives can stick to substrates together strongly after the bonds are aged for from about 5 seconds to about 30 minutes. After being conditioned at room temperature for no more than about 24 hours, the adhesive bonds weaken significantly and can be broken interfacially without adhesive transfer to one of the two substrates.

By weaken considerably means that the bond strength, at 24 hours, is reduced to at least 50% of the bond strength present at 30 minutes. Preferable, bond strength is reduced by 75%, even more preferable bond strength is decreased by 95%. It will be appreciated that the bond force required to secure an article in place with sufficient bond strength will vary based on the size of the bottle, the weight of the bottle, the amount of adhesive used, the line speed, and the like. When tested in accordance with the method described in the Examples below, the bond force between 5 seconds and 30 minutes is greater than 1 KgF and the bond force at 24 hours is less than 1 KgF, said greater bond force being at least twice that of the lesser bond force.

The adhesive used in the practice of the invention must bond strongly to the substrates to be bonded together, yet exhibit excellent releasing characteristics when the bottle is subsequently removed from the substrate. The adhesive must release cleanly from the bottle and not cause fiber tear of the substrate to which the bottle was bonded.

Use of “release cleanly” and “no adhesive transfer” are interchangeably used throughout this disclosure and mean that there is no visible transfer of adhesive to the bottle.

Adhesives used in the practice of the invention are low application temperature hot melt adhesives with excellent bonding and releasing characteristics. Low application temperature hot melt adhesives are defined herein as hot melt adhesive that can be applied at a temperature of from about 200° to about 300° F. The advantages of using low application temperature hot melt adhesives include reduced number and/or capacity of heating elements required in the hot melt adhesive tanks, reduced volatile emissions, reduced risk of burn injury, and reduced wear and tear on the application equipment. While several low application temperature hot melt adhesives are available commercially, none have both good bonding and releasing characteristics.

Low application temperature hot melt adhesives have now been formulated that have both excellent bonding and good release characteristics. The adhesive compositions may be used for the bonding of paper, metal, plastic, wood, and combinations thereof. These adhesives may advantageously be used to temporarily bond one substrate to a second different substrate, e.g., bond plastic bottles to a paperboard packaging substrate. The adhesive used in the practice of the invention must bond strongly to the substrates to be bonded together, yet exhibit excellent releasing characteristics such that when the bottle is subsequently removed from the substrate, the adhesive releases cleanly from the bottle and does not cause fiber tear of the substrate to which the bottle was bonded.

The adhesives useful in the practice of the invention are those that can stick to substrates strongly after the bonds are aged or conditioned 5 seconds to about 30 minutes. The bond remains strong throughout this range. However after being conditioned at room temperature for no longer than about 24 hours, the adhesive bonds weaken significantly and can be easily broken interfacially without adhesive transfer to one of the two substrates.

One specific application for this adhesive is in the packaging of a container, e.g., a food container. The invention is particularly useful in the packaging of a plurality of containers, e.g. plastic bottles of water. In one embodiment, a paperboard substrate such as cardboard or corrugated board is used as a platform or palette for the article or articles (e.g., bottles) to be packaged.

While the article to be packaged is described in more detail with respect to the article being a plurality of plastic bottles, the invention is not to be so limited. Glass, plastic (e.g., PET, HDPE), plastic-coated glass, plastic-coated cardboard containers and the like are encompassed as are other goods. It is also understood that the article packaged may be a single article or a plurality of articles.

In the practice of the invention, adhesive is placed on the paperboard substrate and then the bottle is positioned onto the adhesive present on the paperboard substrate. The adhesive secures the bottles in place while an outer wrapping of, for example, a heat shrinkable plastic film is disposed around the bottles and shrunk. The packaged bottles may be stored and/or shipped to a desired destination. The bottles may be separated by a store clerk for placing on the supermarket shelf or in a convenience store refrigerator case, or by a homeowner ready for use or refrigeration. The packaged bottles, after aging for a period of about 24 hours, easily release from the paperboard substrate, optionally upon application of only slight force.

A bond is herein considered to be a strong bond if it has a bond force at least 2 times the bond force at 24 hours. The adhesive, when tested by the method described herein, will have a bond force of greater than about 1 kilogram force (KgF), more typically greater than about 2 KgF, more preferably greater than about 3 KgF.

A bond is considered to have good release characteristic if, following 24 hours of aging, it has a bond force of less than one half the bond strength shown at 5 seconds to 30 minutes of aging. The adhesive, when tested by the method described herein, will have a bond force of less than about 1 KgF, more typically less than about 0.5 KgF, more preferably less that 0.1 KgF.

Use of the term conditioned and aging are used interchangeable herein and means that following bond formation, the bonded substrates are left undisturbed at room temperatures.

One embodiment of the invention is directed to a method of at least temporarily bonding one substrate to a second different substrate. In one aspect of the invention, after aging for from about 5 seconds to about 30 minutes, one substrate is strongly bonded to a second substrate using a hot melt adhesive. E.g., after aging for from 5 seconds and through to about 30 minutes the bond force is at least twice as great as the bond force exhibited at 24 hours. After aging for a period of no more than about 24 hours, the adhesive bond weakens considerably (e.g., a bond force is less than 50% of the bond force exhibited at an aging time of 5 seconds to 30 minutes) and the bond can be broken interfacially without adhesive transfer to one of the two substrates.

Lack of adhesive transfer means that the substrate releases cleaning from the adhesive. By releasing cleaning means that there is substantially no visible adhesive residue remaining of the substrate.

The adhesives of the invention are non-blocking, so that exposure to elevated temperatures, e.g., such as may be encountered during trucking of goods, will not cause the adhesive to bond to the released substrate.

The adhesive compositions may be used for the bonding of paper, metal, plastics, wood, and combinations thereof. The adhesives bond two different substrates together. By different substrates means that at least the surfaces of the substrates differ. For example the adhesive may be used to bond a cardboard substrate to a plastic coated cardboard substrate. In one embodiment the first substrate and the second substrate may both comprises paper or paperboard. In another embodiment the first substrate is a paperboard and said second substrate is coated paperboard, plastic, glass or metal. In a preferred embodiment, the second substrate is the surface of a container.

In one preferred aspect of this embodiment, containers and the like are temporarily secured to a packaging substrate during packaging.

The container may be made of paperboard or coated paperboard, plastic, glass or metal. The container may be a box (e.g., juice boxes or the like), bottle, jar, tubular food containers or the like. Packaged articles include but are not limited to consumer goods such as food and beverages, e.g., packaged beverage containers (e.g., beer bottles, juice boxes and bottles and the like), packaged food containers (e.g., boxes, jars and/or cans of snacks, soup, dog food and the like).

Packaging substrate materials include virgin and recycled kraft, high and low density kraft, chipboard and various types of treated and coated kraft and chipboard. Composite materials are also used for packaging applications such as for the packaging of alcoholic beverages. These composite materials may include chipboard laminated to an aluminum foil which is further laminated to film materials such as polyethylene, mylar, polypropylene, polyvinylidene chloride, ethylene vinyl acetate and various other types of films. Additionally, these film materials also may be bonded directly to chipboard or kraft. The aforementioned substrates by no means represent an exhaustive list, as a tremendous variety of substrates, especially composite materials, find utility in the packaging industry.

The adhesive may be applied to the packaging substrate in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary.

Instead of applying the adhesive to the substrate immediately on the packaging line, the adhesive my be pre-applied to the packaging substrate and then reactivated during the packaging operation.

Reactivation, as this term is used herein, refers to an adhesive that resides on at least a portion of at least one substrate to be bonded. A reactivatable hot melt adhesive is one that has been applied to a substrate in the molten state and allowed to cool, i.e., solidify, thereon. The solidified adhesive present on the substrate is thereafter exposed to a reactivation means whereby the adhesive is reactivated or heated to a molten state, brought in contact with a second substrate and allowed to cool or solidify, thereby bonding the two substrate together. The application of the adhesive onto a substrate for later activation or “reactivation” is referred to herein, and in the art as a “pre-applied” adhesive. The adhesive present on the substrate may be reactivated anytime after initial application to the substrate for bonding to a second substrate. The reactivation means preferable acts to preferentially heat the adhesive present on the substrate without substantially increasing the temperature of the substrate surface.

The pre-applied adhesive may by activated heat, forced air, near infra-red (NIR) lamp, laser, and the like. Sources of thermal energy are well know and familiar to skilled practitioners.

When using a NIR energy source for activation, the time to activate may advantageously be accelerated by incorporation into the adhesive of an effective amount of a NIR absorber. The energy-absorbing ingredient selected for use may be dissolved and/or dispersed within the adhesive composition. Pigments and organic dyes are particularly useful energy-absorbing ingredients for use in the practice of the invention. Near infrared absorbing dyes and pigments are particularly preferred for use in the practice of the invention, but the invention is not limited thereto.

It will be appreciated that NIR energy intensity may be controlled to control the speed of activation by, e.g., controlling the number and/or the power intensity of the lamps used. Of course other NIR energy sources such as NIR lasers may alternatively be used.

Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxy-naphthylazo)azo-benzene), Solvent Green, dyes such as Forest Green and Royal Blue masterbatch dye available from Clariant, cyanine-based dyes, oxides such as such as titanium dioxide, and metals such as antimony, tetrakis)dialkylaminophenyl)aminium dyes, cyanine dyes, squarylium dyes and the like.

Pigments, such as carbon black and graphite, are particulate in nature and will usually have somewhat of a spherical shape with average particle sizes in the range of about 0.01 to about 7 microns. Pigment particles aggregate, so aggregate size will be larger. The pigment aggregate size in hot melt adhesives will preferably be smaller than about 500 microns. Aggregate sizes of less than about 100 microns are preferred, more preferably smaller than about 50 microns.

A wide variety of organic NIR triggers are described in the literature and are available for use in the practice of the invention. Such compounds include cyanine, metal complexes, quinone, azo, radical multiphenylmethane, perylene, aromatic annulenes, fluorenylium. Such triggers possess various absorption characteristics. For example, halogen substituted 1,4,5,8-tetraanilioanthraquinones have excellent transmittance in the vicinity of 860 nm and can absorb NIR in other ranges. Another example is squaraine, which is characterized by intense narrow absorption bands at relatively long wavelength. Also specifically designed phthalocyanine compounds have been demonstrated exhibiting high transmittance to visible light and offering high efficient cut of near infrared.

Preferred energy-absorbing ingredients for use in the practice of the invention are broad band near IR absorbers such as Epolight 1125 (Epolene, Inc), SDA6248 (H.W. Sands Corp.), SDA2072 (H.W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Preferred energy absorbing ingredients will have an absorption in the range of from about 400 nm to about 100,000 nm, more preferably from about 700 nm to about 10,000 nm, even more preferably from about 750 nm to about 5000 nm.

Thus, an embodiment of the invention encompasses packaging materials, such as a corrugated palette, having a reactivatable adhesive applied thereon.

The invention is further illustrated by the following non-limiting examples.

### EXAMPLES

Adhesive samples 1-4, having the formulation shown in Table 1, were prepared using a single blade mixer at temperature of 300° F. Adhesive samples 1-4 and adhesive sample 5, a low application temperature hot melt adhesive commercially available from National Starch and Chemical Company, Bridgewater, NJ, were subjected to the following tests.

Viscosity of the hot melt adhesives was measured using a Brookfield Thermalsel viscometer with a number 27 spindle. Results are shown in Table 2.

The bonding and releasing characteristics of HMAs was evaluated as follows:

Plastic containers with outer diameter of 2.75 inches were first filled with 1 lb water at ambient temperature. The containers were then are bonded to corrugate paperboards using a 0.12 inch bead width of HMA. The bonds formed between the container and the corrugate board were conditioned at room temperature for varied periods of time and were then destroyed under tensile mode. The resulting bond force, adhesive transfer, and fiber tear were recorded. Bond force was measured using a Kanebo or using an Instron tensile tester at a pull speed of 50 inches per minute.

Table 3 shows the relationship between bond force and aging time for bonds formed between PET bottles and corrugated paper boards with the various adhesives. In Table 3, the bond force shown represents the average of multiple (3-5 trials) which has been simplified for brevity. In all cases, actual data for 24 hours is less than one-half of the bond force tested for all times from 5 seconds to 30 minutes. Table 4 shows fiber tear at various aging times and adhesive transfer to the PET bottles at 24 hr aging time.

Table 5 shows the relationship between bond force and aging time for bonds formed between HDPE bottles and corrugated paper boards with the various adhesives. In Table 5, the bond force shown represents the average of multiple (3-5 trials) which has been simplified for brevity. In all cases, actual data for 24 hours is less than one-half of the bond force tested for all times from 5 seconds to 30 minutes. Table 6 shows fiber tear at various aging times and adhesive transfer to the HDPE bottles at 24 hr aging time.

TABLE 1

| | Sample 1 | Sample 2 | Sample 3 | Sample 4 |
|---|---|---|---|---|
| Irganox 1010 | 0.5 | 0.5 | 0.5 | 0.5 |
| Shell Callista wax 158 | 30 | 22 | 30 | 30 |
| Lotryl 28BA175 | | | 20 | |
| Sylvalite RE 100L | 10 | 10 | | |
| Sylvalite RE 110L | | | 5 | 5 |
| Elvax 410 | | | 15 | 12 |
| Elvax 210 | 10 | 25 | | |
| Elvax 420 | | | | 23 |
| Elvax 240 | 15 | 10 | | |
| Enable EN 33330 | 10 | | | |
| Sylvares ZT 106LT | | | 15 | 15 |
| Norsolene A-110 | 10 | 25 | | |
| Multiwax 180M | 7 | 8 | | |
| Wingtack Extra | 8 | | | |
| Eastotac H130R | | | 15 | 15 |

TABLE 2

| | Sample | Sample | Sample | Sample | Sample |
|---|---|---|---|---|---|
| HMA | 1 | 2 | 3 | 4 | 5 |
| Viscosity @ | 3125 | 3470 | 2635 | 3025 | 1000 |
| 250° F. (cp) | | | | | |
| Viscosity @ | 4200 | | | | |
| 235° F. (cp) | | | | | |

TABLE 3

| | Sample | Sample | Sample | Sample | Sample |
|---|---|---|---|---|---|
| HMA | 1 | 2 | 3 | 4 | 5 |
| Adhesive application | 235 | 250 | 250 | 250 | 250 |
| temperature (° F.) | | | | | |
| Bond force | | | | | |
| at different | | | | | |
| aging time (KgF) | | | | | |
| 5 s | >3 | >3 | >3 | >3 | 1-2 |
| 10 s | >3 | >3 | >3 | >3 | 1-2 |
| 1 min | >3 | >3 | >3 | 2-3 | 1-2 |
| 2 min | 1-2 | 2-3 | >3 | 1-2 | 1-2 |
| 5 min | 2-3 | 1-2 | 1-2 | <1 | 1-2 |
| 15 min | 1-2 | 1-2 | 1-2 | <1 | <1 |
| 30 min | 1-2 | 1-2 | 1-2 | <1 | <1 |
| 24 hr | <1 | <1 | <1 | <1 | <1 |

TABLE 4

| | Sample | Sample | Sample | Sample | Sample |
|---|---|---|---|---|---|
| HMA | 1 | 2 | 3 | 4 | 5 |
| Adhesive application | 235 | 250 | 250 | 250 | 250 |
| temperature (° F.) | | | | | |
| Fiber tear | | | | | |
| at different | | | | | |
| aging time | | | | | |
| 5 s | Y | Y | Y | Y | N |
| 10 s | Y | Y | Y | Y | Y |
| 1 min | N | Y | Y | N | N |
| 2 min | N | N | N | N | N |
| 5 min | N | N | N | N | N |
| 15 min | N | N | N | N | N |
| 30 min | N | N | N | N | N |
| 24 hr | N | N | N | N | N |
| Adhesive transfer | N | N | N | N | Y |
| after being aged | | | | | |
| for 24 hr | | | | | |

TABLE 5

| | Sample | Sample | Sample | Sample | Sample |
|---|---|---|---|---|---|
| HMA | 1 | 2 | 3 | 4 | 5 |
| Adhesive application | 235 | 250 | 250 | 250 | 250 |
| temperature (° F.) | | | | | |
| bond force | | | | | |
| at different | | | | | |
| aging time (KgF) | | | | | |
| 5 s | >3 | >3 | >3 | >3 | 1-2 |
| 10 s | >3 | >3 | >3 | 2-3 | 1-2 |
| 1 min | 1-2 | 1-2 | 1-2 | 1-2 | 1-2 |
| 2 min | 1-2 | 1-2 | 1-2 | <1 | 1-2 |
| 5 min | 2-3 | 2-3 | 1-2 | <1 | <1 |
| 15 min | 1-2 | 1-2 | 1-2 | <1 | <1 |
| 30 min | 1-2 | 1-2 | 1-2 | <1 | <1 |
| 24 hr | <1 | <1 | <1 | <1 | <1 |

TABLE 6

| | Sample | Sample | Sample | Sample | Sample |
|---|---|---|---|---|---|
| HMA | 1 | 2 | 3 | 4 | 5 |
| Adhesive application | 235 | 250 | 250 | 250 | 250 |
| temperature (° F.) | | | | | |
| Fiber tear | | | | | |
| at different | | | | | |
| aging time | | | | | |
| 5 s | Y | Y | Y | Y | N |
| 10 s | Y | Y | Y | Y | Y |
| 1 min | N | Y | N | N | N |
| 2 min | N | N | N | N | N |
| 5 min | N | N | N | N | N |
| 15 min | N | N | N | N | N |
| 30 min | N | N | N | N | N |
| 24 hr | N | N | N | N | N |
| Adhesive transfer | N | N | N | N | Y |
| after being aged | | | | | |
| for 24 hr | | | | | |

As shown in Table 3 and 4 (performance of bonds made from PET bottles on corrugated paperboard), Samples 1, 2 and 3 had good bond strength (bond force >1 KgF) at varied aging times from 5 s to 30 min. After being conditioned for 24 hr, bonds in Samples 1, 2 and 3 had good releasing performance, with bond force less than 1 KgF, and had no adhesive transfer to the PET bottles. Bonds in sample 4 and sample 5 weakened prematurely with bond force less than 1 KgF at aging time from 15 to 30 minutes. Additionally, adhesive transfer to PET bottle was observed for tests using Sample 5. The hot melt adhesive Samples 1-3 meet desired bonding and releasing performance for use in the practice of the invention.

As shown in Tables 5 and 6 (performance of bonds made from HDPE bottles on corrugated board), Samples 1, 2 and 3 had good bonding characteristics at aging time less than 30 min with bond force greater than 1 KgF. After being aged for 24 hr, bonds in Sample 1, 2, and 3 had good releasing performance, with bond force less than 1 KgF, and also did not have adhesive transfer to HDPE bottles. Samples 4 and 5 had weak bonds (<1 KgF) after being aged for 1 min or longer. Additionally, adhesive transfer to the HDPE bottles was observed for Sample 5 at 24 hr aging. Therefore, the hot melt adhesives of Samples 1, 2 and 3 possessed the desired bonding and releasing requirements for use in the practice of the invention.

1. A method of bonding a first substrate to a second different substrate comprising applying a low application temperature hot melt adhesive to a first substrate surface, and contacting the adhesive present on said first substrate surface with a surface of a second substrate, thereby bonding the first and second substrates together, wherein from about 5 seconds to within 30 minutes of said contact, said adhesive bonds said first and second substrates together with a bond force at least twice the bond force shown at 24 hours of said contact, and wherein the bond force decreases over time such that by said 24 hours said substrates can be easily separated without adhesive transfer to one of the two substrates.

2. The method of claim 1 where the bond force is reduced by at least 75%.

3. The method of claim 1 where the bond force is reduced by at least 95%.

4. The method of claim 1 wherein at least one of said first substrate and said second substrate comprises paper or paperboard.

5. The method of claim 4 wherein said at least one of said first substrate and said second substrate comprises corrugated paperboard.

6. The method of claim 1 herein said first substrate is a paperboard and said second substrate is plastic glass or metal.

7. The method of claim 1 wherein said adhesive comprises a melt index of less than about 400 g/10 min, a wax content of greater than about 40 wt %, and a viscosity at 250° F. of less than about 4000 cp.

8. A composite comprising one substrate bonded to a second different substrate with a low application temperature hot melt adhesive that is capable of bonding to substrates strongly after the bonds are aged for a predetermined first period of time and after aging for an additional predetermined second period of time, the adhesive bonds weaken significantly and can be broken interfacially without adhesive transfer to one of two substrates.

9. The composite of claim 8 wherein said first period of time is from about 5 seconds to about 30 minutes and said second period of time is less than about 24 hours.

10. A method of packaging an article comprising applying a low application temperature hot melt adhesive to the surface of a packaging substrate, positioning said article in contact with the adhesive present on the packaging substrate, whereby the adhesive secures the article in place during transport down the packaging line and/or while an outer wrapping is disposed around the article and packaging substrate, said adhesive bonding the packaging substrate to a surface of said article, and wherein from about 5 seconds to within 30 minutes of said contact, said adhesive bonds said first and second substrates together with a bond force at least twice the bond force shown at 24 hours of said contact, and wherein the bond force decreases over time such that by said 24 hours said substrates can be easily separated without adhesive transfer to the surface of said article.

11. The method of claim 10 wherein the packaging substrate is a piece of paperboard.

12. The method of claim 10 wherein said article is a metal, plastic or glass article.

13. The method of claim 10 wherein said article is a plurality of bottles.

14. The method of claim 9 wherein said bottles are plastic bottles.

15. A method of packaging an article comprising reactivating an adhesive preapplied to the surface of a packaging substrate, positioning an article in contact with the reactivated adhesive present on the packaging substrate, whereby the adhesive secures the article in place during transport down the packaging line and/or while an outer wrapping is disposed around the article and packaging substrate, said adhesive securing the article with strongly after the bonds are aged for a predetermined first period of time and after aging for an additional predetermined second period of time, the adhesive bonds weaken significantly and can be broken interfacially without adhesive transfer to one of two substrates.

16. A papberboard palette having disposed on at least a portion thereof a reactivatable adhesive, which adhesive, upon reactivation, is capable of bonding said paperboard palette to a substrate strongly after the bonds are aged for a first predetermined period of time and after aging for an additional second predetermined period of time, the adhesive bonds weaken significantly and can be broken interfacially without adhesive transfer to said substrate and without fiber tear of the paperboard palette.
